(19) United States
(12) Patent Application Publication
(10) Pub. No.: US 2015/0137781 A1
(43) Pub. Date: May 21, 2015

(54) LOW DROPOUT CIRCUIT CAPABLE OF CONTROLLED STARTUP AND METHOD OF CONTROLLING SAME

(71) Applicant: Silicon Works Co., Ltd., Daejeon (KR)

(72) Inventors: Wanyuan Qu, Daejeon (KR); Young Jin Woo, Daejeon (KR); Jin Yong Jeon, Daejeon (KR); Dae Keun Han, Daejeon (KR); Young Suk Son, Daejeon (KR)

(73) Assignee: Silicon Works Co., Ltd.

(21) Appl. No.: 14/593,856

(22) Filed: Jan. 9, 2015

Related U.S. Application Data
(63) Continuation of application No. PCT/KR2013/006448, filed on Jul. 18, 2013.

(30) Foreign Application Priority Data
Sep. 5, 2012 (KR) 10-2012-0098426

(51) Int. Cl. G05F 1/56

(52) U.S. Cl. CPC G05F 1/56
USPC 323/280

(57) ABSTRACT

A low dropout (LDO) circuit capable of controlled startup and a method of controlling the same are disclosed herein. The LDO circuit includes an amplifier, a pass element, and a startup control circuit. The amplifier receives a feedback voltage determined by an output voltage and a predetermined reference voltage, and provides a first voltage determined by the feedback voltage and the reference voltage. The pass element is connected to an input power and an output node for providing the output voltage. The startup control circuit includes a current source, and forward one of the first voltage, provided by the amplifier based on the level of the output voltage, and a second voltage, generated using the current source, to the gate of the pass element.

### CROSS-REFERENCE TO RELATED APPLICATION

This application is a continuation of PCT/KR2013/006448 filed on Jul. 18, 2013, which claims priority to Korean Application No. 10-2012-0098426 filed on Sep. 5, 2012, which applications are incorporated herein by reference.

### TECHNICAL FIELD

The present invention relates to a low dropout (LDO) circuit and, more particularly, to an LDO circuit capable of controlled startup, which limits an inrush current during startup without influencing a feedback loop, thereby controlling the slew rate of an output voltage.

### BACKGROUND ART

An LDO regulator provides output power at a level lower than that of input power, and provides stable output power even when input power is unstable.

Generally, an LDO regulator includes an error amplifier, a pass element (a transistor), an output voltage division resistor, and an output capacitor.

The basic operation of an LDO regulator is based on, in order to adjust the magnitude of a load current, feeding back an error voltage Vₑᵣᵣₒᵣ between a divided output voltage achieved by an output voltage division resistor and a band-gap reference voltage V_{ref}, amplifying the error voltage Vₑᵣᵣₒᵣ via an error amplifier, and then adjusting the gate voltage of a pass element.

When the LDO is activated, the output capacitor of the LDO is rapidly charged to a nominal voltage that results in a large amount of current. The power of the LDO included in a system may have variable characteristics and limitations. Due to the limited impedance of the power supply, the initial charging current of this type of LDO may be limited. When the LDO is activated, inrush current may occur. A large amount of inrush current may drop voltage level of power to a dangerously low level, and may sometimes cause a system-level problem.

However, most LDOs do not provide an inrush current-limiting characteristic. Due to the absence of an inrush current-limiting characteristic, a serious problem may occur when the LDO requires a high-load current or an input power source is a switching converter. For example, the output of the switching converter may be pulled down by a large amount of inrush current that is charged into an output capacitor, may trigger a switching regulator enable circuit, and may forcibly reset a circuit in some cases. Furthermore, a step-down converter may repeatedly alternate between a charged state and a reset state.

As a result, there is a need for a startup circuit that is capable of limiting an initial inrush current when an LDO is being activated.

### SUMMARY OF THE DISCLOSURE

Accordingly, the present invention has been made to solve the above problems occurring in the prior art, and an object of the present invention is to provide an LDO circuit capable of controlled startup, which can easily control slew rate using a current source located out of feedback loop during an early stage of startup, and thus can limit inrush current during startup, and a method of controlling the same.

More specifically, the present invention is intended to construct a control means capable of controlling slew rate between the output terminal of an amplifier and the gate terminal of a pass element, to forward a voltage, generated using a current source included in the control means, to the gate terminal during the early stage of startup, and to forward a voltage, output from the amplifier, to the gate terminal if the output voltage of the pass element is equal to or higher than a predetermined target voltage, thereby controlling an inrush current and an output voltage during the whole process of startup.

In accordance with an aspect of the present invention, there is provided an LDO circuit, including an amplifier configured to receive a feedback voltage determined by an output voltage and a predetermined reference voltage and to provide a first voltage determined by the feedback voltage and the reference voltage; a pass element connected to an input power and an output node for providing the output voltage; and a startup control circuit configured to include a current source, and to forward one of the first voltage, provided by the amplifier based on the level of the output voltage, and a second voltage, generated using the current source, to the gate of the pass element.

The pass element may be an n-type pass transistor, and the current source may be connected to a predetermined third voltage. The startup control circuit may further include a selection circuit configured to provide one of the first voltage and the second voltage to the gate of the pass element; and a selection control circuit configured to detect the level of the output voltage, to compare the detected level of the output voltage with a predetermined target voltage; and to control the selection circuit to provide the first voltage to the gate if the level of the output voltage is equal to or higher than the target voltage and to provide the second voltage to the gate if the level of the output voltage is lower than the target voltage.

The third voltage may be a ramp voltage.

The startup control circuit may further include a ramp voltage generation circuit configured to generate a ramp voltage using an output current of the current source; a selection circuit configured to provide one of the generated ramp voltage and the first voltage to the gate of the pass element; and a selection control circuit configured to detect a level of the output voltage, to compare the detected level of the output voltage with a predetermined target voltage, and to control the selection circuit to provide the first voltage to the gate if the level of the output voltage is equal to or higher than the target voltage and to provide the ramp voltage to the gate if the level of the output voltage is lower than the target voltage.

The ramp voltage generation circuit may include a capacitor connected to the output terminal of the current source and a ground; and a discharge element connected to the output terminal of the current source and the ground, and configured to discharge the capacitor under the control of the selection control circuit.

The amplifier may be an operational transconductance amplifier (OTA); and the startup control circuit may further include a ramp voltage generation circuit configured to generate a ramp voltage using an output current of the current source; a first switching element configured such that a gate, drain and source thereof are connected to an output terminal of the ramp voltage generation circuit, the third voltage, and the gate of the pass element, respectively; and an output control circuit configured to detect a level of the output voltage, to compare the detected level of the output voltage with a predetermined target voltage, and to control an output of the ramp voltage generation circuit based on a result of the comparison.

The LDO circuit may further include a feedback circuit connected to the output node and one of input terminals of the amplifier, and configured to provide the feedback voltage to the amplifier.

The pass element may be a p-type pass transistor, and a node of one side of the current source mat be connected to a ground. The startup control circuit may further include a selection circuit configured to connect one of a node of the other side of the current source and output terminal of the amplifier to the gate of the pass element; and a selection control circuit configured to detect a level of the output voltage, to compare the detected level of the output voltage with a predetermined target voltage, and to control the selection circuit to connect the output terminal of the amplifier to the gate if the level of the output voltage is equal to or higher than the target voltage and to connect the node of the other side of the current source to the gate if the level of the output voltage is lower than the target voltage.

If the level of the output voltage is equal to or higher than a predetermined target voltage, the startup control circuit may forward the first voltage to the gate of the pass element, and may turn off the current source.

In accordance with another aspect of the present invention, there is provided a method of controlling an LDO circuit, including providing, by an amplifier receiving a feedback voltage determined by an output voltage and a predetermined reference voltage, a first voltage determined by the feedback voltage and the reference voltage; generating a second voltage using a current source; and selectively forwarding one of the first voltage and the second voltage, based on the level of the output voltage, to the gate of a pass element connected between an input power and an output node providing the output voltage.

Generating the second voltage using the current source may include generating the second voltage using the current source located out of a feedback loop including the amplifier.

In accordance with still another aspect of the present invention, there is provided a method of controlling an LDO circuit, including providing, by an amplifier receiving a feedback voltage determined by an output voltage and a predetermined reference voltage, a first voltage determined by the feedback voltage and the reference voltage; generating a second voltage using a current source during a process of startup of an input power; forwarding the second voltage to the gate of a pass element connected between the input power and an output node for providing the output voltage during the process of the startup of the input power; and forwarding the first voltage to the gate of the pass element when a normal operation has been entered after the process of the startup of the input power.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates the configuration of an LDO circuit according to the present invention;

FIG. 2 illustrates the configuration of an embodiment of the LDO circuit illustrated in FIG. 1;

FIG. 3 illustrates the configuration of another embodiment of the LDO circuit illustrated in FIG. 1;

FIG. 4 illustrates a graph of the transient response of the output voltage illustrating the operation of the LDO circuit according to the present invention;

FIG. 5 illustrates the configuration of still another embodiment of the LDO circuit illustrated in FIG. 1;

FIG. 6 illustrates the configuration of still another embodiment of the LDO circuit illustrated in FIG. 1;

FIG. 7 illustrates a graph of the transient response of the V₁ and V₂ illustrating the ramp voltage generation circuit illustrated in FIG. 5;

FIG. 8 illustrates an operation flowchart of a method of controlling an LDO circuit according to an embodiment of the present invention; and

FIG. 9 illustrates an operation flowchart of a method of controlling an LDO circuit according to another embodiment of the present invention.

### DETAILED DESCRIPTION OF THE DISCLOSURE

The terms used herein are used merely to describe specific embodiments, but are not intended to limit the present invention. The singular expressions used herein include plural expressions unless explicitly stated otherwise in the context thereof. It should be appreciated that in this application, the use of the terms “include(s),” “comprise(s)”, “including” and “comprising” is intended to denote the presence of the characteristics, numbers, steps, operations, elements, or components described herein, or combinations thereof, but is not intended to exclude the probability of presence or addition of one or more other characteristics, numbers, steps, operations, elements, components, or combinations thereof.

Unless defined otherwise, all terms used herein, including technical terms or scientific terms, have the same meanings as those generally understood by persons of ordinary skill in the technical field to which the present invention pertains. The terms, such as terms that are generally used and defined in dictionaries, should be construed as having meanings identical to those that are used in the context of related technology, and should not be construed as having ideal or excessively formal meanings unless explicitly defined otherwise.

Preferred embodiments of the present invention will be described in detail with reference to the accompanying drawings. In the following description of the present invention, if it is determined that detailed descriptions of related well-known configurations or functions may make the gist of the present invention obvious, the detailed descriptions will be omitted.

However, the present invention is not restricted or limited to the embodiments. The same reference symbols represented throughout the drawings designate the same elements.

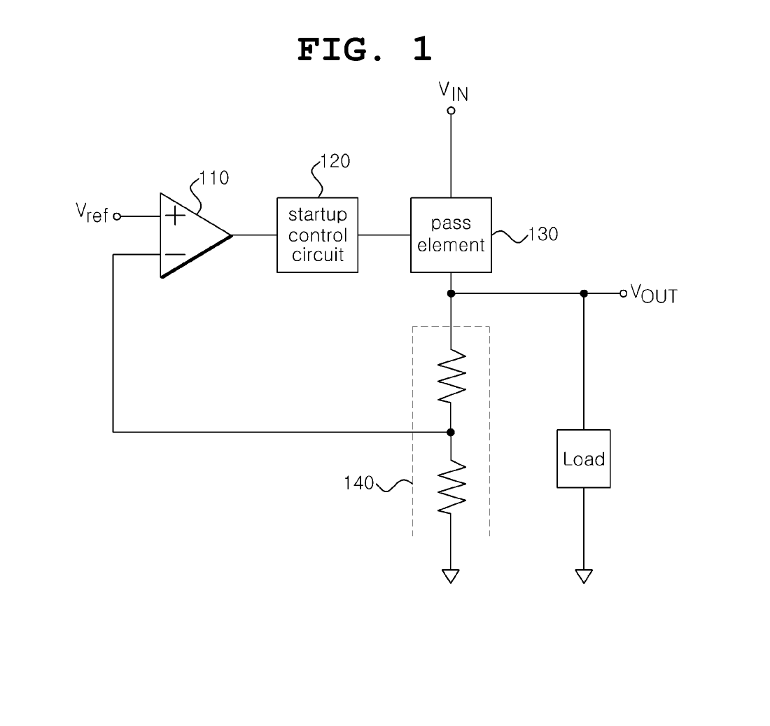

A low dropout (LDO) circuit capable of controlled startup and a method of controlling the same according to an embodiment of the present invention are described in detail below with reference to FIGS. 1 to 9.

FIG. 1 illustrates the configuration of the LDO circuit according to the present embodiment.

Referring to FIG. 1, the LDO circuit according to the present embodiment includes an amplifier 110, a startup control circuit 120, a pass element 130, and a feedback circuit 140.

The amplifier 110 receives a predetermined reference voltage V_{ref} and a feedback voltage forwarded via the feedback circuit 140, and may adjust the gate voltage of the pass element 130 using an output voltage corresponding to the two voltages received via two terminals in a normal operation mode.

The pass element 130 is connected to input power V_{IN} and the feedback circuit 140, has a gate voltage adjusted by the voltage forwarded via the startup control circuit 120, generates an output voltage V_{OUT} using the adjusted gate voltage and the input power V_{IN}, and provides the output voltage V_{OUT} to an output load.

In this case, the pass element 130 may be a transistor, and may be an n-type pass transistor or a p-type pass transistor. With reference to the following embodiments, the circuit configuration of a case where the pass element 130 is an n-type pass transistor and the circuit configuration of a case where the pass element 130 is a p-type pass transistor will be described more specifically.

Generally, the pass element 130 used in the LDO circuit generates the output voltage V_{OUT} using the input power V_{IN} and is designed for the purpose of driving the output load, and thus has a relatively large W/L ratio. In this case, the area that is occupied by the pass element 130 is relatively large, and thus parasitic capacitance constituting the input capacitance (gate-source or gate-drain capacitance) of the pass element 130 also has a very large value. The parasitic input capacitance that the pass element 130 has corresponds to a relatively very large value as the on-chip capacitance of an integrated circuit.

The present invention provides technology for controlling the slew rate of an output voltage to be fallen within a predictable range using the parasitic input capacitance of the pass element 130 without requiring the addition of separate capacitance.

The feedback circuit 140 distributes a part of the output voltage V_{OUT} using a plurality of resistors (voltage divider), and feeds back the partial (divided) voltage to the one of input terminal of the amplifier 110. That is, the feedback circuit 140 provides a feedback voltage to the amplifier 110.

The startup control circuit 120 includes a current source, selects one of a voltage (hereinafter referred to as the “first voltage”) provided by the amplifier 110 based on the level of the output voltage V_{OUT} of the pass element 130 and a second voltage generated using the current source, and forwards the selected voltage to the gate terminal of the pass element 130.

In this case, the startup control circuit 120 detects the output voltage V_{OUT} of the pass element 130. If the level of the detected output voltage V_{OUT} is lower than a predetermined target voltage, the startup control circuit 120 may apply the second voltage generated using the current source to the gate terminal of the pass element 130, thereby applying a voltage constantly increasing by time to the gate terminal of the pass element 130 in order to limit an inrush current that may occur during early stage of startup. If the level of the detected output voltage V_{OUT} is equal to or higher than the predetermined target voltage, the startup control circuit 120 may apply the first voltage output from the amplifier 110 to the gate of the pass element 130, thereby limiting an initial inrush current by keeping the slew rate uniform during a later stage of startup or normal mode after startup, and then keeping the output voltage V_{OUT} constant.

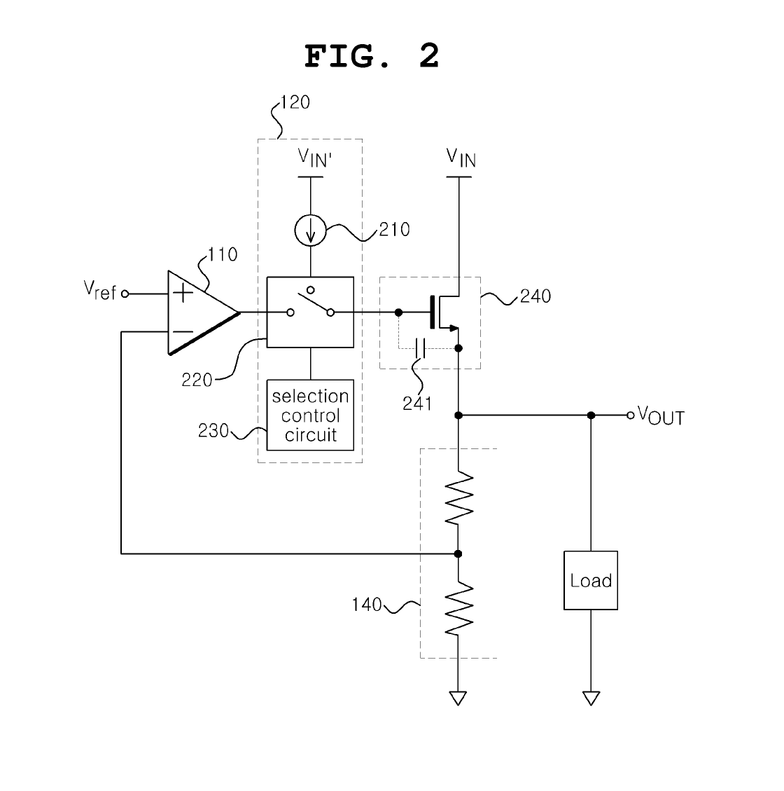

The LDO circuit according to the present invention is described below with reference to FIGS. 2 to 7.

FIG. 2 illustrates the configuration of an embodiment of the LDO circuit illustrated in FIG. 1, that is, the configuration of an embodiment of the case where the pass element is an n-type pass element.

Referring to FIG. 2, the LDO circuit includes an amplifier 110, a startup control circuit 120, an n-type pass element 240, and a feedback circuit 140. Since the amplifier 110 and the feedback circuit 140 are the same as those described with reference to FIG. 1, descriptions thereof are omitted.

The n-type pass element 240 is an n-type transistor, and may be an NMOS transistor or the like.

In the initial stage of a startup process, a constant current is transferred from the startup control circuit 120 to the parasitic input capacitance 241 of the n-type pass element 240, and is charged into the parasitic input capacitance 241. In this case, the relationship between a voltage across both terminals of the parasitic input capacitance 241 and the constant current from the current source may be expressed by I=C·dV/dt. In this case, if the current has a constant level I, the voltage across both terminals of the parasitic input capacitance 241 will increase at a constant slew rate.

While the parasitic input capacitance 241 is being charged, the influence of the transfer of the constant current from the startup control circuit 120 to an output node is relatively very small. Furthermore, at this time, the gate-source voltage of the n-type pass element 240 does not exceed a threshold voltage Vₜₕ, and thus the input power V_{IN} is not transferred to the output voltage.

If the parasitic input capacitance 241, particularly the gate-source capacitance, has been charged to have the voltage level reaching the threshold voltage, the n-type pass element 240 is turned on, and thus the input power V_{IN} starts to be transferred to the output voltage. However, although the input power V_{IN} is higher than the gate voltage of the n-type pass element 240, the output voltage has a voltage value that is smaller than the gate voltage of the n-type pass element 240 due to a voltage drop by the threshold voltage. Accordingly, the slew rate of the output voltage can be controlled based on the constant current level I and the value of the parasitic input capacitance 241 to be fallen within a constant range.

As described above, the n-type pass element 240 has a relatively large W/L value and a relatively large area, and thus the value of the parasitic input capacitance 241 can be estimated to fall within a constant range with considerable reliability during circuit design. Accordingly, the slew rate of the output voltage may be controlled to be substantially constant using the value of the estimated parasitic input capacitance 241 and the constant current level I of the current source 210 such that it falls within the predictable range.

The LDO circuit and the method of controlling the same according to the present invention can be further optimized under a slow-start condition, and can control the slew rate of the output voltage so that it is constant using the parasitic input capacitance 241, the constant current level I of the current source, and the gate-source threshold voltage drop phenomenon of the n-type pass element 240. The area of an added circuit can be minimized by using the parasitic input capacitance 241 without additionally designing a capacitance having a relatively large value required for the above purpose.

Furthermore, the startup control circuit 120 that will be described in detail below does not influence the feedback loop 140 with respect to the amplifier 110 and is not influenced by the feedback loop 140, thereby enabling the stable operation of the circuit.

The startup control circuit 120 includes a current source 210, a selection circuit 220, and a selection control circuit 230.

The current source 210 may be connected between a predetermined voltage V_{IN′} and the selection circuit 220, and may output a constant current or a time-varying current.

In this case, the voltage V_{IN′} input to the current source 210 may be a constant voltage having a fixed value or a ramp voltage varying over time.

The selection circuit 220 selectively connects one of the output terminal of the amplifier 110 and the output terminal of the current source 210 with the gate terminal of the n-type pass element 240.

In this case, the selection circuit 220 may use an element, such as a CMOS transistor switch or the like, and may connect one of the output terminal of the amplifier 110 and the output terminal of the current source 210 to the gate terminal of the n-type pass element 240 under the control of the selection control circuit 230.

The selection control circuit 230 detects the output voltage V_{OUT} output via the output terminal of the n-type pass element 240, and compares the detected output voltage V_{OUT} with the predetermined target voltage. If the output voltage V_{OUT} is lower than the target voltage (e.g. it can be regarded as “early stage” of the startup process), the selection control circuit 230 controls the selection circuit 220 so that the output terminal of the current source 210 is connected to the gate terminal of the n-type pass element 240. In contrast, if the output voltage V_{OUT} is equal to or higher than the target voltage (e.g. it can be regarded as “later stage” of the startup process or “normal mode” after startup process), the selection control circuit 230 controls the selection circuit 220 so that the output terminal of the amplifier 110 is connected to the gate terminal of the n-type pass element 240.

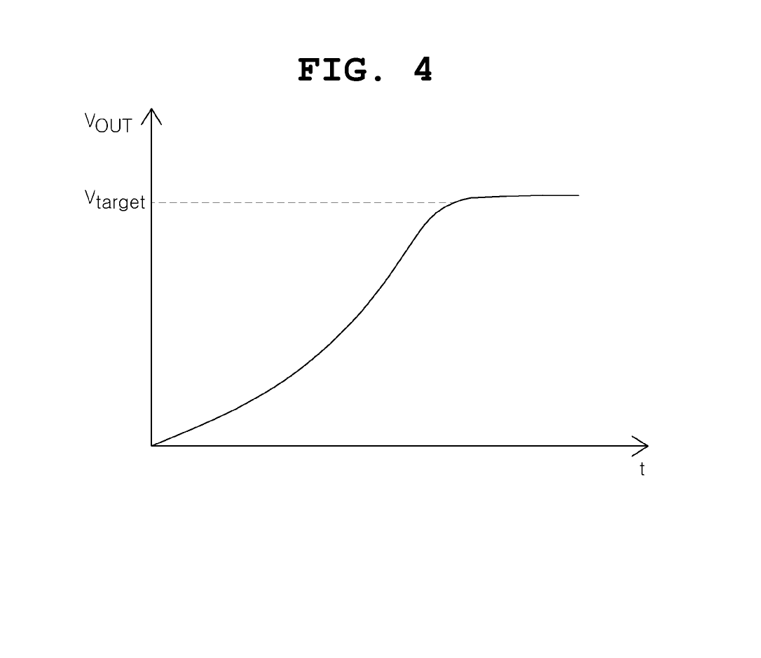

That is, as illustrated in FIG. 4, the selection control circuit 230 controls the selection circuit 220 so that the output of the current source 210 is forwarded to the gate terminal of the n-type pass element 240 during early stage of startup, thereby charging the parasitic capacitance 241 of the n-type pass element 240 with the current output from the current source 210, so that the output voltage V_{OUT} increases at a constant slew rate over time. Thereafter, if the output voltage V_{OUT} is equal to or higher than the target voltage V_{target}, the selection control circuit 230 controls the selection circuit 220 so that the output of the amplifier 110 is input to the gate terminal of the n-type pass element 240, thereby continuously providing the stable output voltage V_{OUT} to the output load of the n-type pass element 240.

The target voltage V_{target} to be compared with the output voltage V_{OUT} may be equal to the voltage ultimately output from the LDO circuit, for example, a multiple of V_{ref}, otherwise the target voltage V_{target} may be lower than the ultimate output voltage, the multiple of V_{ref}, or may vary depending on circumstances. It depends on various examples.

Furthermore, the selection control circuit 230 may control the turning on and off of the current source 210. For example, if the current source 210 is connected to the gate terminal of the n-type pass element 240 by the selection circuit 220, the selection control circuit 230 turns on the current source 210, thereby providing the output current of the current source 210 to the gate terminal of the n-type pass element 240. If the connection of the n-type pass element 240 to the gate terminal is released by the selection circuit 220, the selection control circuit 230 may control the current source 210 to be turned off.

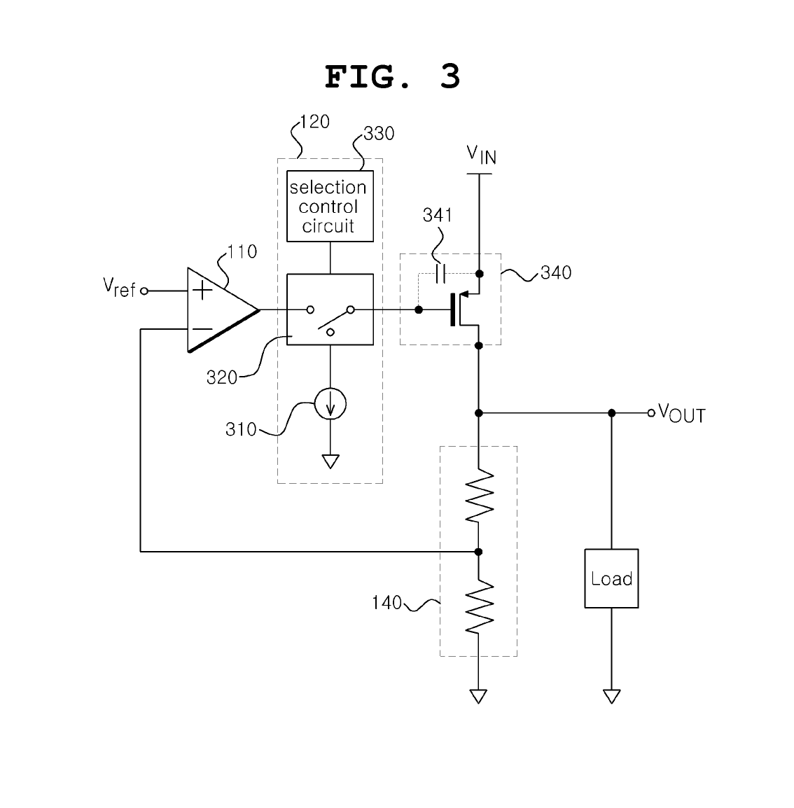

FIG. 3 illustrates the configuration of another embodiment of the LDO circuit illustrated in FIG. 1, that is, the configuration of an embodiment of the case where the pass element is a p-type pass element.

Referring to FIG. 3, the LDO circuit includes an amplifier 110, a startup control circuit 120, a p-type pass element 340, and a feedback circuit 140. Since the amplifier 110 and the feedback circuit 140 are the same as those described with reference to FIG. 1, descriptions thereof are omitted.

The p-type pass element 340 is a p-type transistor, and may be a PMOS transistor switch or the like. The p-type pass element 340 may be charged with a parasitic capacitance 341 (having a gate-source voltage) formed between a gate terminal and a source terminal.

The startup control circuit 120 includes a current source 310, a selection circuit 320, and a selection control circuit 330.

The current source 310 is formed using a pull-down scheme of being connected to a ground and the selection circuit 320.

The selection circuit 320 selectively connects one of the output terminal of the amplifier 110 and the current source 310 with the gate terminal of the p-type pass element 340.

In this case, the selection circuit 320 may use an element, such as a CMOS transistor switch, and may connect one of the output terminal of the amplifier 110 and the current source 310 to the gate terminal of the p-type pass element 340 under the control of the selection control circuit 330. The selection control circuit 330 controls the selection circuit 320 so that the current source 310 is connected to the gate terminal of the p-type pass element 340 during early stage of startup, thereby charging the parasitic capacitance 341 of the p-type pass element 340 using the current source 310, so that the output voltage V_{OUT} increases at a constant slew rate over time. Thereafter, if the output voltage V_{OUT} is equal to or higher than the target voltage V_{target}, the selection control circuit 330 controls the selection circuit 320 so that the output terminal of the amplifier 110 is connected to the gate terminal of the p-type pass element 340.

In this case, the selection control circuit 330 may control the turning on and off of the current source 310 via a connection relation between the current source 310 and the selection circuit 320. Since this has been described with reference to FIG. 2, a description thereof is omitted.

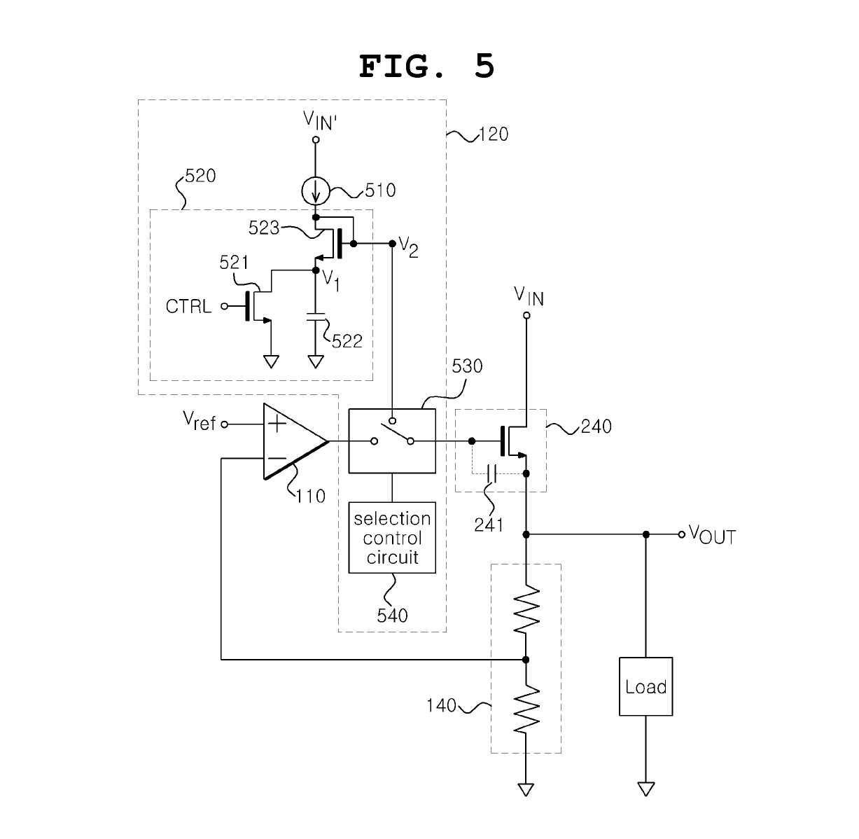

FIG. 5 illustrates the configuration of still another embodiment of the LDO circuit illustrated in FIG. 1, in which the configuration of the startup control circuit illustrated in FIG. 2 is different.

Accordingly, since the amplifier 110, the n-type pass element 240, and the feedback circuit 140 illustrated in FIG. 5 are the same as the amplifier, the n-type pass element and the feedback circuit illustrated in FIG. 2, descriptions thereof are omitted.

The startup control circuit 120 illustrated in FIG. 5 includes a current source 510, a ramp voltage generation circuit 520, a selection circuit 530, and a selection control circuit 540.

In this case, since the current source 510 and the selection circuit 530 are also the same as the current source 210 and the selection circuit 220 illustrated in FIG. 2, descriptions thereof are omitted.

The ramp voltage generation circuit 520 generates a ramp voltage using an output current output from the current source 510, and includes a first switching element 521, a capacitor 522, and a second switching element 523.

The capacitor 522 generates a ramp voltage using the output current output from the current source 510.

The first switching element 521 may discharge the capacitor 522 in response to an on/off control signal CTRL.

In this case, the turning on and off of the first switching element 521 may be controlled by an on/off control signal output from the selection control circuit 540.

The second switching element 523 is an element for compensating for the threshold voltage Vₜₕ of the n-type pass element 240, and outputs a voltage V₂ higher than a ramp voltage V₁, to the selection circuit 530. The ramp voltage V₁ is output from the capacitor 522, V₂ is higher than V₁ by the threshold voltage Vₜₕ of the n-type pass element 240.

Depending on examples, the second switching element 523 may be omitted.

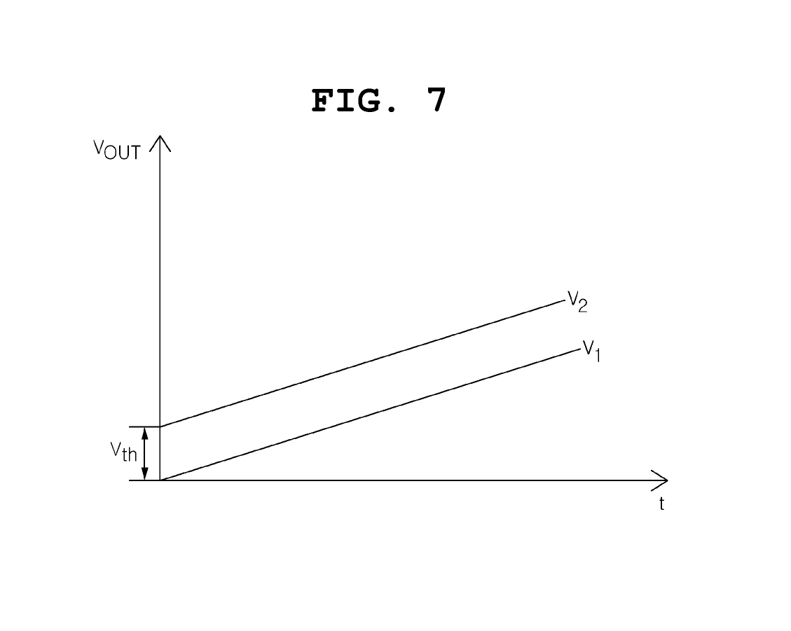

As illustrated in FIG. 7, the ramp voltage V₁ is provided through the charging of the capacitor 522 by the current source 510. Since the voltage V₂ obtained by level-shifted from the ramp voltage V₁ by the threshold voltage Vₜₕ of the second switching element 523, is provided, a voltage output via the n-type pass element 240 can maintain slew rate at the slope of the ramp voltage V₁ provided by the charging of the capacitor 522. It will be apparent that threshold voltage drop of the n-type pass element 240 (between gate and source) can be compensated by the second switching element 523 in a startup process. It will be also apparent that normal operation can be entered after startup.

The selection control circuit 540 controls the selection circuit 530 so that the output voltage of the ramp voltage generation circuit 520 is input to the gate terminal of the n-type pass element 240 during early stage of startup, detects the output voltage V_{OUT} of the n-type pass element 240, and controls the selection circuit 530 so that the output of the amplifier 110 is input to the gate terminal of the n-type pass element 240 if the detected output voltage V_{OUT} is equal to or higher than a predetermined target voltage.

That is, the selection control circuit 540 detects the output voltage V_{OUT} of the n-type pass element 240, and controls the selection circuit 530 so that the gate terminal of the n-type pass element 240 is connected to one of the output terminal of the amplifier 110 and the output terminal of the ramp voltage generation circuit 520 in response to the detected output voltage V_{OUT}.

Furthermore, the selection control circuit 540 may discharge or charge the capacitor 522 by controlling the turning on or off of the first switching element 521 that constitutes a part of the ramp voltage generation circuit 520.

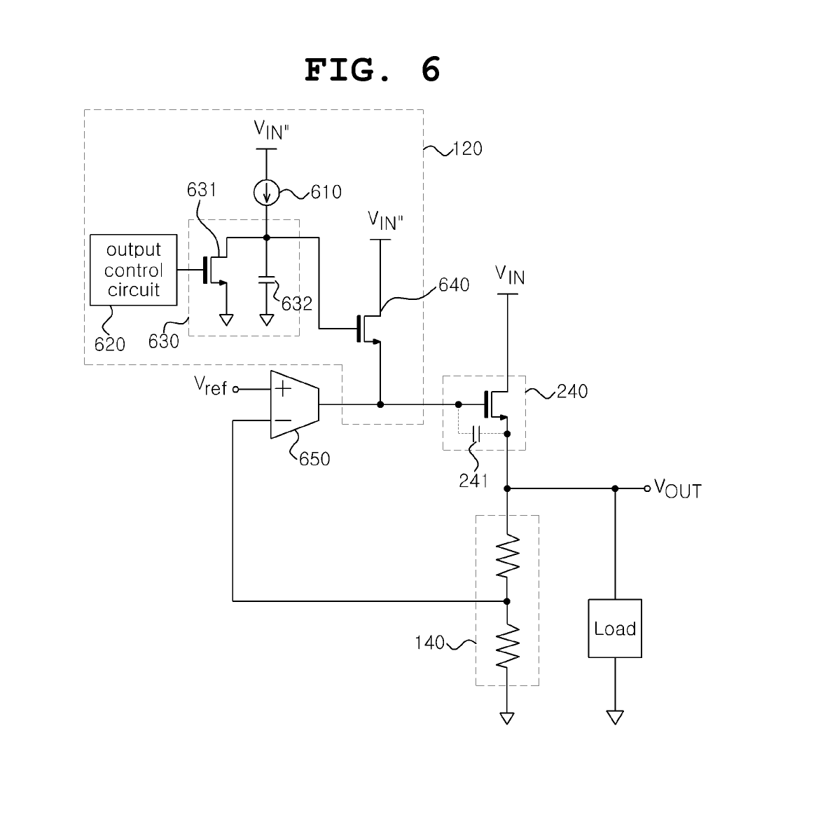

FIG. 6 illustrates the configuration of still another embodiment of the LDO circuit illustrated in FIG. 1, that is, the configuration of a case where an n-type pass element is used and an operational transconductance amplifier (OTA) is used as an amplifier.

As illustrated in FIG. 6, in the LDO circuit, the configurations of an OTA amplifier 650 and an startup control circuit 120 are different from those of FIG. 5, and the configurations of an n-type pass element 240 and an feedback circuit 140 are the same as those of FIG. 5.

Since the LDO circuit uses the OTA amplifier 650 of FIG. 6, a current output from the OTA amplifier 650 is limited, and thus the operation of controlling slew rate during startup can be performed without the configuration of the selection circuit 530 illustrated in FIG. 5.

The startup control circuit 120 includes a current source 610, a ramp voltage generation circuit 630, a third switching element 640, and an output control circuit 620.

In this case, the input voltage V_{IN″} of the current source 610 may be the same as or be different from the input voltage V_{IN′} of the current source 510 illustrated in FIG. 5. Since the operation of the current source 610 is the same as that of the current source 510 illustrated in FIG. 5, a description thereof is omitted.

The ramp voltage generation circuit 630 generates a ramp voltage using an output current output from the current source 610, and includes a first switching element 631 and a capacitor 632.

The capacitor 632 generates a ramp voltage using an output current output from the current source 610, and the first switching element 631 discharges the capacitor 632 under control by the output control circuit 620.

The output control circuit 620 detects the output voltage V_{OUT} of the n-type pass element 240, provides an off control signal to the first switching element 631 if the output voltage V_{OUT} is lower than a predetermined target voltage, and provides an on control signal to the first switching element 631 if the output voltage V_{OUT} is equal to or higher than the target voltage, thereby controlling the charging and discharging of the capacitor 632.

The gate, drain and source of the third switching element 640 are connected to the output terminal of the ramp voltage generation circuit 630, the predetermined voltage V_{IN″}, and the gate terminal of the n-type pass element 240, respectively. The third switching element 640 can forward the ramp voltage to the gate terminal of the n-type pass element 240, level-shifted by a threshold voltage drop from a voltage of the output terminal of the ramp voltage generation circuit 630.

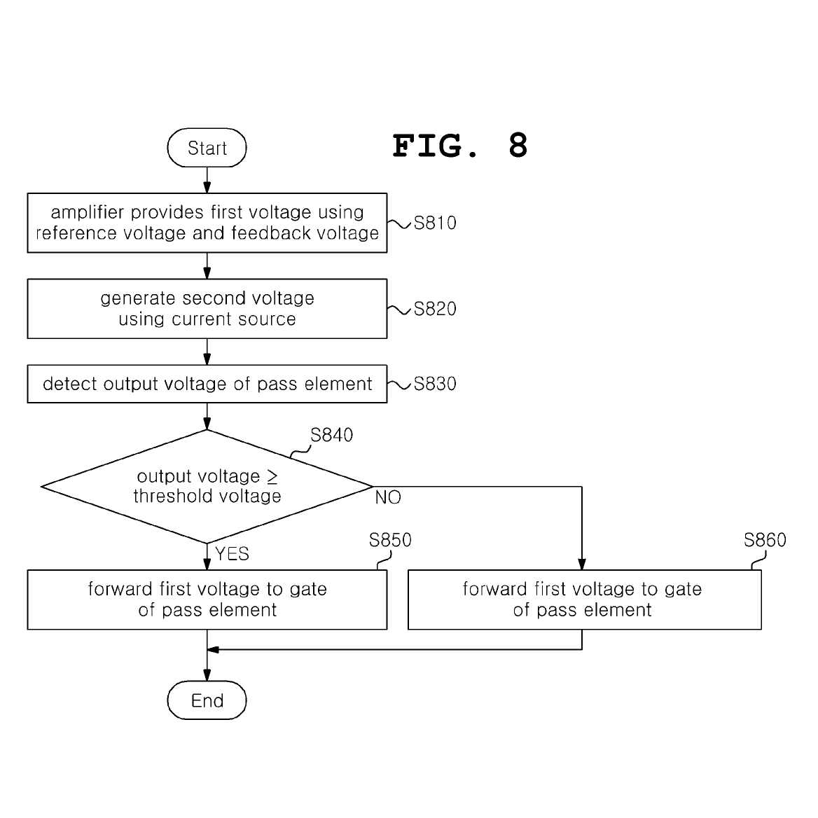

FIG. 8 illustrates an operation flowchart of a method of controlling an LDO circuit according to an embodiment of the present invention.

Referring to FIG. 8, the amplifier receives a predetermined reference voltage and a feedback voltage from the feedback circuit and then provides a first voltage to the pass element using the received two voltages at step S810.

A second voltage is generated using the current source at step S820.

In this case, if the pass element is an n-type transistor, a ramp voltage may be generated as a second voltage using the output current of the current source. If the pass element is a p-type transistor, one side of the current source is in a state of being connected to the ground, and the other side may generate the second voltage.

In this case, the current source may be located out of the feedback loop having the amplifier, and the second voltage may be generated using the current source functions independently of the feedback loop as described above.

Once the second voltage has been generated using the current source, the output voltage of the pass element is detected and it is determined whether the detected output voltage is equal to or higher than a predetermined target voltage at steps S830 and S840.

It is controlled such that the second voltage generated by the current source is input to the gate of the pass element if, as a result of the determination at step S840, the output voltage is lower than the target voltage while the first voltage provided by the amplifier is input to the gate of the pass element if the output voltage is equal to or higher than the target voltage at steps S850 and S860.

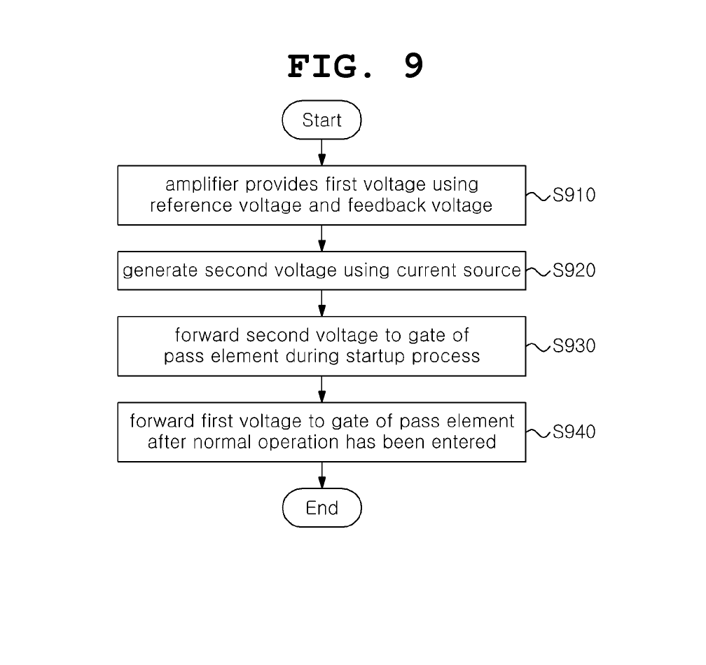

FIG. 9 illustrates an operation flowchart of a method of controlling an LDO circuit according to another embodiment of the present invention.

Referring to FIG. 9, the amplifier receives a predetermined reference voltage and a feedback voltage from a feedback circuit and then provides a first voltage to the pass element using the received two voltages at step S910.

A second voltage is generated using the current source at step S920.

In this case, the current source may be have a role of independent of the feedback loop having the amplifier, and the second voltage may be generated using the current source independently from the feedback loop as described above.

Once the second voltage has been generated using the current source, The LDO may be controlled such that the second voltage generated using the current source is input to the gate of the pass element during the process of the startup of input power and the first voltage is input to the gate of the pass element when a normal operation stage has been entered after the process of the startup of input power at steps S930 and S940.

In this case, the pass element is connected between the input power V_{IN} and the output node for providing the output voltage V_{OUT}, as illustrated in FIG. 1.

According to the present invention, the control means capable of controlling slew rate may be implemented between the output terminal of the amplifier and the gate terminal of the pass element. A voltage generated using the current source included in the control means may be provided to the gate terminal during “early stage” of startup, a voltage output from the amplifier may be provided to the gate terminal if the output voltage of the pass element is equal to or higher than the predetermined target voltage (e.g. it has been entered into the “later stage” or “normal operation mode”) after the startup, thereby controlling an inrush current and the slew rate of an output voltage so that they fall within a target range during a startup process.

Furthermore, the present invention is configured to forward a ramp voltage directly to the gate terminal during early stage of startup, and to forward a voltage, output from the amplifier, to the gate terminal if the output voltage of the pass element is equal to or higher than the target voltage (e.g. it has been entered into the “later stage” or “normal operation mode”), thereby easily controlling slew rate during startup without using a feedback capacitor. That is, the present invention can control the slew rate of the output voltage using a circuitry independent of the feedback loop during a startup process.

Although the present invention has been described with reference to specific details, such as the specific components, and the limited embodiments and drawings, these are provided merely to help a general understanding of the present invention, and the present invention is not limited thereto. Furthermore, those having ordinary knowledge and/or skill in the technical field to which the present invention pertains may make various modifications and variations from the above detailed description.

Therefore, the spirit of the present invention should be not defined based only on the above detailed description, and not only the following claims but also all equivalent to the claims should be construed as falling within the scope of the spirit of the present invention.

What is claimed is:

1. A low dropout (LDO) circuit, comprising:
an amplifier configured to:
receive a feedback voltage determined by an output voltage and a predetermined reference voltage; and
provide a first voltage determined by the feedback voltage;
a pass element connected to an input power and an output node for providing the output voltage; and
a startup control circuit configured to:
include a current source; and
forward one of the first voltage, provided by the amplifier based on a level of the output voltage, and a second voltage, generated using the current source, to a gate of the pass element.

2. The LDO circuit of claim 1, wherein the pass element is an n-type pass transistor.

3. The LDO circuit of claim 2, wherein the current source is connected to a predetermined third voltage, and
the startup control circuit further comprises:
a selection circuit configured to provide one of the first voltage and the second voltage to the gate of the pass element; and
a selection control circuit configured to:
detect the level of the output voltage;
compare the detected level of the output voltage with a predetermined target voltage; and
control the selection circuit to provide the first voltage to the gate if the level of the output voltage is equal to or higher than the target voltage and to provide the second voltage to the gate if the level of the output voltage is lower than the target voltage.

4. The LDO circuit of claim 3, wherein the third voltage is a ramp voltage.

5. The LDO circuit of claim 2, wherein the current source is connected to a predetermined third voltage, and
the startup control circuit further comprises:
a ramp voltage generation circuit configured to generate a ramp voltage using an output current of the current source;
a selection circuit configured to provide one of the generated ramp voltage and the first voltage to the gate of the pass element; and
a selection control circuit configured to:
detect a level of the output voltage;
compare the detected level of the output voltage with a predetermined target voltage; and
control the selection circuit to provide the first voltage to the gate if the level of the output voltage is equal to or higher than the target voltage and to provide the ramp voltage to the gate if the level of the output voltage is lower than the target voltage.

6. The LDO circuit of claim 5, wherein the ramp voltage generation circuit comprises:
a capacitor connected to the output terminal of the current source and a ground; and
a discharge element connected to the output terminal of the current source and the ground, and configured to discharge the capacitor under a control of the selection control circuit.

7. The LDO circuit of claim 2, wherein the current source is connected to a predetermined third voltage, the amplifier is an operational transconductance amplifier (OTA), and
the startup control circuit further comprises:
a ramp voltage generation circuit configured to generate a ramp voltage using an output current of the current source;
a first switching element configured such that a gate, drain and source thereof are connected to an output terminal of the ramp voltage generation circuit, the third voltage, and the gate of the pass element, respectively; and
an output control circuit configured to:
detect a level of the output voltage;
compare the detected level of the output voltage with a predetermined target voltage; and
control an output of the ramp voltage generation circuit based on a result of the comparison.

8. The LDO circuit of claim 1, further comprising a feedback circuit connected to the output node and one of input terminals of the amplifier, and configured to provide the feedback voltage to the amplifier.

9. The LDO circuit of claim 1, wherein the pass element is a p-type pass transistor.

10. The LDO circuit of claim 9, wherein a node of one side of the current source is connected to a ground, and
the startup control circuit further comprises:
a selection circuit configured to connect one of a node of the other side of the current source and output terminal of the amplifier to the gate of the pass element; and
a selection control circuit configured to:
detect a level of the output voltage;
compare the detected level of the output voltage with a predetermined target voltage; and
control the selection circuit to connect the output terminal of the amplifier to the gate if the level of the output voltage is equal to or higher than the target voltage and to connect the node of the other side of the current source to the gate if the level of the output voltage is lower than the target voltage.

11. The LDO circuit of claim 1, wherein the startup control circuit, if the level of the output voltage is equal to or higher than a predetermined target voltage, forwards the first voltage to the gate of the pass element, and disables the current source.

12. A method of controlling an LDO circuit, comprising:
providing, by an amplifier receiving a feedback voltage determined by an output voltage and a predetermined reference voltage, a first voltage determined by the feedback voltage and the reference voltage;
generating a second voltage using a current source; and
selectively forwarding one of the first voltage and the second voltage, based on a level of the output voltage, to a gate of a pass element connected between an input power and an output node providing the output voltage.

13. The method of claim 12, wherein:
the pass element is an n-type transistor;
generating the second voltage using the current source comprises generating a ramp voltage as the second voltage using an output current of the current source; and
selectively forwarding one of the first voltage and the second voltage comprises forwarding the first voltage to the gate if the level of the output voltage is equal to or higher than a target voltage, and forwarding the second voltage to the gate if the level of the output voltage is lower than the target voltage.

14. The method of claim 12, wherein:
the pass element is a p-type transistor;
generating the second voltage using the current source comprises generating, by a node of one side of the current source, the second voltage when a node of the other side of the current source has been connected to a ground; and
selectively forwarding one of the first voltage and the second voltage comprises forwarding the first voltage to the gate if the level of the output voltage is equal to or higher than a target voltage, and forwarding the second voltage to the gate if the level of the output voltage is lower than the target voltage.

15. The method of claim 12, wherein generating the second voltage using the current source comprises generating the second voltage using the current source located out of a feedback loop including the amplifier.

16. A method of controlling an LDO circuit, comprising:
providing, by an amplifier receiving a feedback voltage determined by an output voltage and a predetermined reference voltage, a first voltage determined by the feedback voltage and the reference voltage;
generating a second voltage using a current source during a process of startup of an input power;
forwarding the second voltage to a gate of a pass element connected between the input power and an output node for providing the output voltage during the process of the startup of the input power; and
forwarding the first voltage to the gate of the pass element when a normal operation has been entered after the process of the startup of the input power.

17. The method of claim 16, wherein generating the second voltage using the current source comprises generating the second voltage using the current source located out of a feedback loop including the amplifier.
